(19) United States
(12) Patent Application Publication
(10) Pub. No.: US 2013/0309377 A1
(43) Pub. Date: Nov. 21, 2013

(54) METHOD AND APPARATUS FOR PRODUCING A DOUGH

(71) Applicant: HB-FEINMECHANIK GmbH & Co. KG, Metten (DE)

(72) Inventor: Bonifaz ENDRASS, Gotteszell (DE)

(73) Assignee: HB-FEINMECHANIK GmbH & Co. KG, Metten (DE)

(21) Appl. No.: 13/954,845

(22) Filed: Jul. 30, 2013

Related U.S. Application Data
(63) Continuation of application No. PCT/EP2012/000401, filed on Jan. 31, 2012.

(30) Foreign Application Priority Data
Jan. 31, 2011 (EP) 11000742.4

(51) Int. Cl. A21D 8/02

(52) U.S. Cl. CPC A21D 8/025
USPC 426/498; 99/352

(57) ABSTRACT

The invention relates to a method and an apparatus for producing a dough, in particular a dough for bread for toasting, by means of an extruder. The extruder has at least two extruder shafts along which kneading elements for admixing a gas into a dough are arranged in at least one kneading section. Gas can be drawn off along a gas-removal section and therefore a defined proportion of the gas is established in the dough. Furthermore, a mould for discharge of the dough is arranged at the output of the extruder. A nozzle device is arranged at an input region of the extruder, it being possible for said nozzle device to be used to spray a preparation liquid onto a dough base material under pressure in order to form a starter dough.

The invention relates to a method for producing a baking dough by means of an extruder. The invention further relates to a device for producing a baking dough with an extruder having at least two extruder shafts, along which kneading elements for admixing a gas into a dough are arranged in at least one kneading section, at least one degassing section for drawing off a gas and setting a defined proportion of the gas in the dough and at least one outlet with a shaping tool for discharging the dough.

The production of dough for toast as a typical baking dough is normally carried out in a discontinuous batch process. In this process, the dough is intially kneaded in large containers. Afterwards, a portioning using weighing means takes place, wherein the dough portions, after having been processed further with a rounder, are left to rest in a pre-proofing cabinet in order that the gluten network and the pore structure develop further. Subsequently, the dough is rolled out before baking. In order to counteract the resultant elongation effect of the pore structure in the dough, the dough portion for a toast baking mold is divided into four pieces, rolled and placed in this rolled shape into the baking mold for baking. Despite this so-called 4-pieces-method an uneven pore structure is perceptible as a so-called shadowy formation in the end product.

A device and a corresponding method for the production of dough can be taken from EP 0 919 127 B1. In this known device, for the production of dough products the flour is introduced separately from a liquid component into the extruder. In the course of the extruder the dough is kneaded and can be discharged as a finished pasta dough.

For the production of pasta dough, a dough mass that is gas-free and as compact as possible is generally intended in order to thereby obtain a firm pasta that is also “al dente” after cooking. An incorporated gas is removed by way of vacuum sections.

In contrast, in the production of a baking dough, especially a baking dough for toast, a dough is intended which, in a subsequent baking process, leads to a pore structure of the baking product.

### BRIEF DESCRIPTION OF THE DRAWINGS

FIG. 1 is a schematic view of a device for producing dough, and

FIG. 2 is a schematic crossectional view of the device of FIG. 1

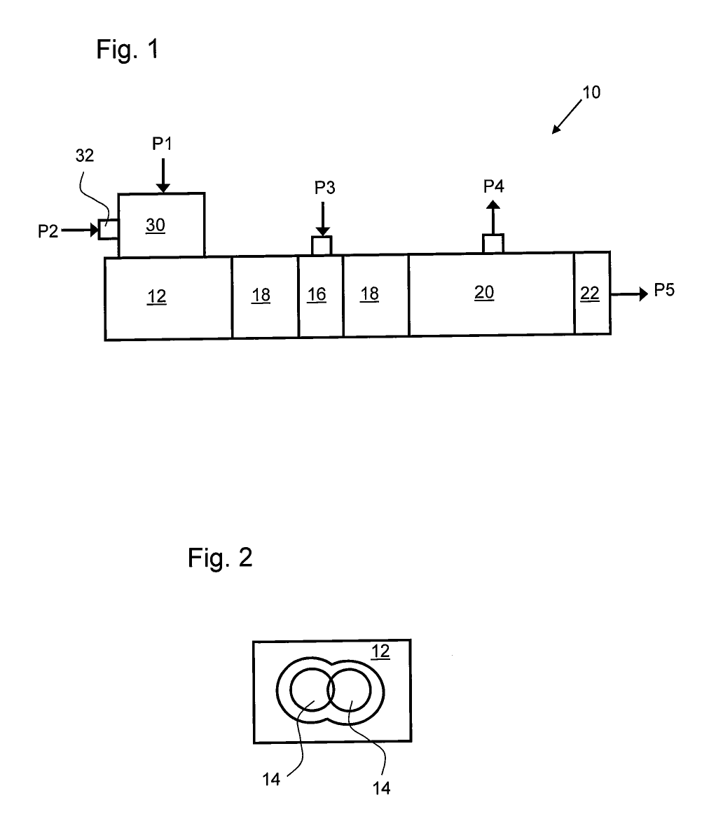

The invention is based on the object to provide a method and a device, with which a baking dough for a baking product can be achieved in an efficient manner whilst allowing for a specific pore structure of the baking product to be set.

In accordance with the invention the object is achieved on the one hand by a method having the features of claim 1 and by a device 10 having the features of claim 12. Preferred embodiments of the invention are stated in the respective dependent claims.

According to the invention a method for producing a baking dough by means of an extruder 12 is provided, wherein
upon introduction into the extruder 12 powdery basic dough material P1, in particular cereal flour, is wetted with a preparation liquid, which is sprayed at a pressure by means of a nozzle means P2 onto the basic dough material so that a starter dough is formed,
the starter dough is kneaded in the extruder by means of kneading elements 14, 14 whilst specifically admixing a gas containing O₂ at P3,
from the kneaded dough, gas containing O₂ is drawn off at P4 along at least one degassing section 20 and
the dough is discharged from the extruder at P5 though a shaping tool 22.

According to a first aspect of the invention the method is carried out in a continuous manner with an extruder 12, wherein, however, as early as at the beginning of the method a starter dough is produced by spraying with a preparation liquid under pressure from a nozzle means P2. The preparation of the starter dough takes place immediately before entry into the extruder or directly in the starting area 30 of the extruder 12, in particular before a kneading of the dough is carried out.

Hence, a preliminary dough product is already present at the beginning of the extruder 12 so that during the subsequent processing into a finished dough by the extruder a lower amount of mechanical energy is required. In this way, the thermal stress of the heat-sensitive dough is reduced considerably. On the whole, the extruder 12 can also be designed with a smaller length, thereby being more compact and altogether more economical. Furthermore, an improved gas absorption can take place in the starter dough, in which a hydration and therefore a formation of the gluten network by the proteins in the basic dough material has already taken place.

During the feeding of the dough through the extruder 12 from the inlet 30 towards the outlet at P5 the proportion of the gas containing O₂, in particular air, within the dough is then set in a defined manner in at least one degassing station 20. In particular, this can be effected by a corresponding pressure setting.

At the beginning a high oxygen content is set. This serves for a rapid and good formation of the gluten network in the dough as a result of oxidation processes. In particular, the injection of oxygen at P3 is set such that in the basic dough material a dissolved oxygen content of 5 to 300 ppm, especially ranging between 10 and 30 ppm, is reached.

Once the gluten network has been formed, a specific reduction of the oxygen proportion by preferably 20% to 30% is effected in the course of the extruder 12. Through this, the further reaction for forming the gluten network is suppressed to a large extent. Moreover, the oxygen reduction induces a change from an elastic property of the dough towards a plastic property. This is especially advantageous for an easy extrusion of the dough and a precise portioning.

One aspect of the invention therefore resides in the fact that the plastic dough properties, which are decisive for the machine processing capability of the dough, are set by specifically controlling the oxygen proportion in the dough.

The dough thus finished is extruded through a shaping tool 22 at the outlet of the extruder so that a ready-made dough is present which can be supplied directly or after a short resting time to a baking process. In particular, on the shaping tool 22 at the outlet of the extruder a haul-off means for continuously hauling off the dough or a cutting means can be provided, through which the plastic dough provided with a uniform density is portioned at the exit.

As basic dough material provision is made, in particular, for a cereal flour or another type of powdery mass, such as semolina. As preparation liquid water is used, in particular, that can be enriched with salt, sugar, oils or further additives, where appropriate. The additives can also be dosed in separately. For improvement and more precise control of the oxidation processes that occur during the formation of the gluten network, ascorbic acid can be added in an especially advantageous manner, by preference with a proportion of 10 to 100 ppm in the dough. In the course of the extruder, further preparation liquid or a different liquid component can be added in the processing chamber of the extruder for the purpose of enriching the dough in terms of taste and color.

A preferred embodiment of the method according to the invention resides in the fact that the gas containing O₂ is introduced into the extruder at a first pressure lying above ambient pressure. Furthermore, it is advantageous if for the admixture of the gas in a kneading section of the extruder the starter dough is kneaded at a second pressure which is different from, in particular lower than the first pressure. As gas containing O₂ use can be made, in particular, of ambient air or a special processing gas that contains a defined oxygen proportion. Through finger-shaped kneading elements projecting radially on the extruder shafts the already sticky starter dough is kneaded and at the same time fed towards the outlet of the extruder. In doing so, additional gas is evenly incorporated into the dough. By reducing the pressure in the kneading section as compared to the pressure, at which the starter dough was produced, an expansion and therefore enlargement of the gas bubbles inside the dough is achieved. The gas bubbles thus enlarged can be divided more easily in the kneading section so that all in all an even better gas distribution is reached in the dough, whereby the oxidation processes are fostered. In specific cases it may also be useful to provide a pressure increase in individual kneading sections. A section-wise pressure setting inside the processing chamber of the extruder is rendered possible by radially projecting housing walls and/or small conveyor screw pitches. In this way, congestion areas are created that only permit a defined passage of dough on the extruder shafts. Especially the inlet or entry area is designed as a pressure chamber so that here a high pressure of 0.5 to 5 bar can be set as compared to ambient pressure.

According to the invention a particularly good, fine gas distribution is achieved by the fact that in the course of the extruder the starter dough is kneaded repeatedly in different kneading sections 18, wherein in-between the kneading sections 18 at least one pressure section 16 with increased pressure is arranged. In particular, at least two kneading sections 18 are provided, in which a kneading of the dough is effected at a lower pressure so that the thereby enlarged gas pores in the dough can be scaled down further and split up. Due to the fact that between the two kneading sections 18 pressure section 16 is arranged, in which a higher pressure is set as compared to the kneading sections, the reduction of the gas volume leads to a stabillization of the pore structure. Basically, in this pressure section 16 a kneading by means of kneading elements can also take place. However, it is preferred that in this section a feeding by the extruder shafts 14 solely takes place. In the subsequent kneading section having a lower pressure again and thereby a set volume expansion of the gas pores, a further fine distribution of the gas in the dough is brought about. A good distribution of the gas containing O₂ ensures a uniform, rapid oxidation. Moreover, following removal of the oxygen a plurality of gas bubble cores remains in the dough. CO₂ released during a fermentation of the dough diffuses to a significant degree into these gas bubble cores, whereby a specific setting of the pore structure of the baking product is achieved. This structure can be very fine-pored in the case of a great number of gas bubble cores or coarse-pored in the case of a smaller number of gas bubble cores, as desired for ciabatta doughs for example.

A section-wise pressure increase inside the extruder housing for the dough processing can be implemented by a corresponding design of the pitch of the screw-shaped extruder shaft segments in this section. If a smaller screw pitch is present the feed rate is reduced, and through a corresponding design of the subsequent extruder shaft segment a pressure increase is brought about. According to the invention it is especially preferred that for pressure increase a pressure fluid is introduced into the extruder at P3. In particular, this can be a gas, such as ambient air, which is supplied under pressure via at least one supply line to a middle section of the extruder.

Basically, an extruder 12 with several extruder shafts can be employed that are driven, in particular, in a unidirectional manner. For the processing of the dough, however, it has proved to be especially useful that the extruder 12 has two extruder shafts (14, 14) that are driven in opposite directions. In a so-called counter-directional extruder with two extruder shafts an especially gentle preparation and feeding of the dough inside the extruder takes place. This prevents an excessive amount of mechanical energy and therefore heat from being introduced into the dough. An overheating of the dough leads to damage of the protein molecules so that a desired gluten network would then no longer develop.

According to the invention it is particularly advantageous for a housing and/or the extruder shafts to be tempered, in particular cooled. For this purpose, the housing or the extruder shafts can be interspersed with cooling channels, through which a cooling fluid is passed. In particular, provision is made in accordance with the invention in that the dough is not heated above a temperature of 30° C. In principle, however, it is also conceivable that a heating fluid is passed through the relevant channels if a defined temperature increase is desired in certain sections for example.

For the production of the starter dough provision is made according to the invention in that the spraying of the preparation liquid onto the basic dough material is effected at a high pressure at P2, in particular a pressure of 10 bar to 100 bar, wherein a hydration of proteins of the basic dough material takes place. The hydration is an essential step for the development of the gluten network. The spraying of the preparation liquid at a high pressure of preferably 30 to 80 bar not only effects a moistening but also has an intensive mechanical impact that is advantageous for the formation of the dough. Since this mechanical impact is solely brought about by way of the liquid, this does not lead to a significant temperature stress of the starter dough so that all in all the method can be carried out in a gentle and very quick way. A total of one or several nozzles 32 can be arranged in the inlet area of the extruder so that a specific impact for the formation of the starter dough is brought about.

To generate a specific pore structure of the finished dough provision is made according to the invention in that in a low-pressure section before an outlet of the extruder a low pressure is set, which is lower than ambient pressure. In particular, provision is made in that between the low-pressure section and the outlet a kneading is carried out in a terminal kneading section. As a result of such a kneading effected in a low-pressure section, the pressure of which is lower than ambient pressure, i.e. room or atmospheric pressure of approximately 1000 mbar, gas containing CO₂ is removed and the desired plastic, dense dough mass is set. Upon exit from the extruder, however, gas bubble cores remain in the dough. During an ensuing fermentation and baking process a very fine-pored structure can thus be attained in the finished baking product. Especially for bread doughs, and in particular for doughs for toast, this is an essential quality characteristic.

Whereas in the conventional production of dough for toast this still has to be rolled out, rolled up and normally placed in four pieces into a toast baking mold according to special method steps, in the method according to the invention the finished dough can be processed immediately. In particular, according to the invention provision is made for the dough to be extruded from the extruder at P5 directly into a mold and to be portioned by a cutting means. The method according to the invention is excellently suitable for bread doughs, especially doughs for toast, but also for all other types of baking dough, such as pizza, pastry, puff pastry or croissant doughs. Alternatively, the dough can also be shaped as a dough sheet and supplied to a lamination facility.

The device according to the invention for producing a baking dough is characterized in that in an inlet area 30 of the extruder a nozzle means 32 is provided, with which, for the purpose of forming a starter dough, a preparation liquid can be sprayed under pressure onto a basic dough material at P2. With this device the previously described method with the stated advantages can be implemented in particular.

An advantageous embodiment of the device 10 according to the invention resides in the fact that several kneading sections 18 with kneading elements are provided, wherein in-between the kneading sections at least one pressure section 16 with an increased pressure is arranged. As described beforehand, through a correspondingly lower pressure setting in at least one preceding kneading section and one following kneading section a specific distribution of the gas in the dough can be achieved.

For pressure setting it is particularly preferred in accordance with the invention that a supply line to the pressure section is designed, via which a pressure fluid can be introduced for a section-wise pressure increase inside the extruder.

1. Method for producing a baking dough by means of an extruder, wherein
a powdery basic dough material, in particular cereal flour, is introduced into the extruder and wetted with a preparation liquid,
in the extruder a dough is kneaded and
the dough is discharged from the extruder through a shaping tool,
wherein
upon introduction immediately before entry and kneading in the extruder the preparation liquid is sprayed by means of a nozzle means onto the basic dough material at a high pressure of 10 bar to 100 bar for the hydration of proteins of the basic dough material, wherein a gluten network is developed by the proteins of the basic dough material and a starter dough is formed,
the starter dough is kneaded in the extruder by means of kneading elements whilst specifically admixing a gas containing O₂, wherein a dissolved oxygen proportion of 5 to 300 ppm is set in the basic dough material, and
from the kneaded dough, gas containing O₂ is drawn off along at least one degassing section and the oxygen proportion is reduced by 20% to 30%.

2. Method according to claim 1,
wherein
the gas containing O₂ is introduced into the extruder at a first pressure lying above ambient pressure.

3. Method according to claim 2,
wherein
for the admixture of the gas in a kneading section of the extruder the starter dough is kneaded at a second pressure which is different from, in particular lower than the first pressure.

4. Method according to claim 1,
wherein
in the course of the extruder the starter dough is kneaded repeatedly in different kneading sections, wherein in-between the kneading sections at least one pressure section with increased pressure is arranged.

5. Method according to claim 1,
wherein
the extruder has two extruder shafts that are driven in opposite directions.

6. Method according to claim 1,
wherein
a housing and/or the extruder shafts are tempered, in particular cooled.

7. Method according to claim 1,
wherein
the spraying of the preparation liquid onto the basic dough material is effected at a pressure of 30 bar to 80 bar, wherein a hydration of proteins of the basic dough material takes place.

8. Method according to claims 1,
wherein
in a low-pressure section before an outlet of the extruder a low pressure is set which is lower than ambient pressure.

9. Method according to claim 8,
wherein
between the low-pressure section and the outlet a kneading is carried out in a terminal kneading section.

10. Method according to claim 1,
wherein
the dough is portioned immediately after exiting from the extruder.

11. Method according to claim 1,
wherein
the dough is extruded from the extruder directly into a baking mold or shaped as a dough sheet and supplied to a lamination facility or dough sheet facility.

12. Device for producing a baking dough with an extruder having
at least two extruder shafts driven in opposite directions, along which kneading elements for admixing a gas into a dough are arranged in at least one kneading section,
at least one degassing section for drawing off a gas and setting a defined proportion of the gas in the dough and
at least one outlet with a shaping tool for discharging the dough,
wherein
in an inlet area of the extruder a nozzle means is provided, with which, for the purpose of forming a starter dough, a preparation liquid can be sprayed at a high pressure of 10 bar to 100 bar onto a basic dough material before entry into the extruder, and
the device is designed and set for carrying out a method according to claim 1, wherein the starter dough is kneaded in the extruder by means of kneading elements whilst specifically admixing a gas containing O₂ and a dissolved oxygen proportion of 5 to 300 ppm is set in the basic dough material and wherein from the kneaded dough, gas containing O₂ is drawn off along the at least one degassing section and the oxygen proportion is reduced by 20% to 30%.

13. Device according to claim 12,
wherein
several kneading sections with kneading elements are provided, wherein in-between the kneading sections at least one pressure section with an increased pressure is arranged.

14. Device according to claim 13,
wherein
a supply line to the pressure section is designed, via which a pressure fluid can be introduced for a section-wise pressure increase inside the extruder.
